(19) United States
(12) Patent Application Publication
(10) Pub. No.: US 2004/0191742 A1
(43) Pub. Date: Sep. 30, 2004

(54) Three-dimensional interactive story book

(76) Inventor: Scott E. Brient, Roswell, GA (US)

Correspondence Address: Scott E.Brient, 625 Highlands Court, Roswell, GA, 30075, US

(21) Appl. No.: 10/815,476

(22) Filed: Mar. 31, 2004

Related U.S. Application Data
(60) Provisional application No. 60/459,096, filed on Mar. 31, 2003.

(51) Int. Cl. G09B 5/00

(52) U.S. Cl. 434/317

(57) ABSTRACT

A three-dimensional story book comprising: (1) an outer housing defining a recess; and (2) one or more story modules within said recess, each of said story modules corresponding to a portion of a story.

### CROSS-REFERENCE TO RELATED APPLICATIONS

This application claims priority from U.S. provisional patent application No. 60/459,096, which was filed on Mar. 31, 2003 and entitled “Three Dimensional Interactive Storybook”, and which is hereby incorporated by reference.

### BACKGROUND OF THE INVENTION

In the past, it has proved challenging to teach children how to properly organize and develop a story, and to interest children in creating and documenting new, well-structured stories. Accordingly, new devices and methods are needed for helping children, and other users, understand the structure of existing stories, and for creating new stories of their own.

### SUMMARY OF THE INVENTION

A method according to one embodiment of the invention comprises the steps of: (1) providing an outer housing defining a recess; and (2) providing one or more story modules within said recess, each of said story modules corresponding to a portion of a story. In one embodiment of the invention, one or more of the story modules comprises a stage surface, and a background surface. The stage surface is configured for supporting one or more props for use in acting out a portion of a story. In one embodiment, the background surfaces are configured for providing a background display that is conducive to conveying the portion of the story being acted out using the props. One or more of the story modules preferably includes one or more props that are stored within an interior portion defined by the story module when the story module is in a closed position, and the story module may be moved from a closed position, in which the story module substantially obstructs access to the props; and an open position, in which the story module does not substantially obstruct access to the props. In one embodiment of the invention, the storybook does not include an outer housing, but is simply comprised of a plurality of story modules.

### BRIEF DESCRIPTION OF THE DRAWINGS

Having thus described the invention in general terms, reference will now be made to the accompanying drawings, which are not necessarily drawn to scale, and wherein:

FIG. 1 depicts a front perspective view of an interactive storybook according to one embodiment of the invention.

FIG. 2 depicts a front view of the interactive storybook of FIG. 1 in which the storybook's door is open.

FIG. 3 depicts a front view of the interactive storybook of FIG. 1 in which the storybook's door is open and two of the nine story modules are removed.

FIG. 4 depicts a perspective view of a story module according to one embodiment of the invention. This figure shows the story module in a closed position.

FIG. 5 depicts a front perspective view of the story module of FIG. 4 in which two of the story module's panels (which are side background panels) have been moved into an open position.

FIGS. 6 and 7 depict front perspective views of the story module of FIG. 4 in which two side background panels are in an open position and two upper panels are being moved into an open position by a user.

FIG. 8 depicts a front perspective view of the story module of FIG. 4 in which the story module is in an open position.

FIG. 9 depicts a top view of a story module according to one embodiment of the invention.

FIG. 10 depicts a story module panel that includes a removable indicia card.

FIG. 11 depicts two panels that are made of a single piece of material and that are configured to rotate relative to one another in a hinged manner due to an indentation in the material.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

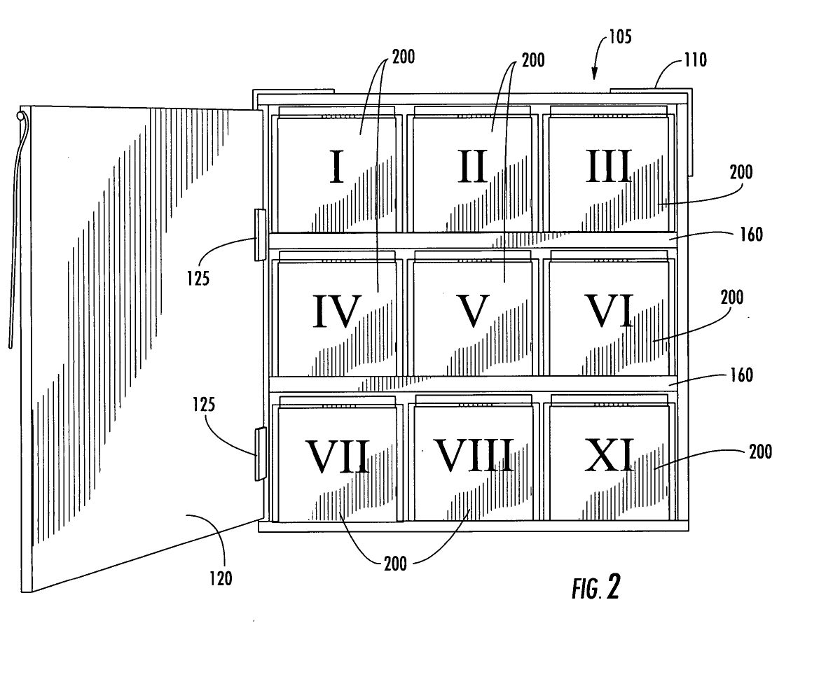

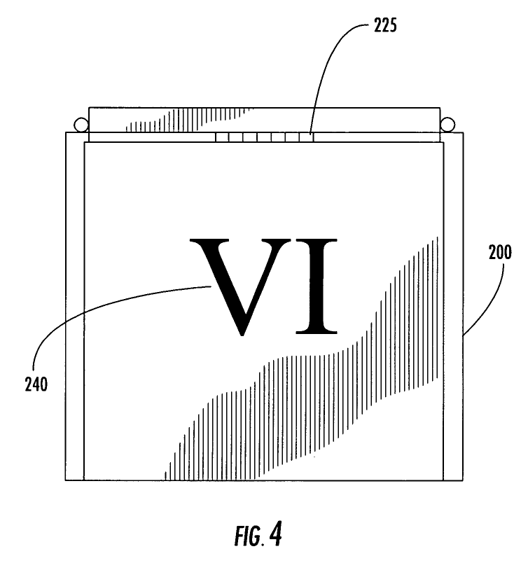

One embodiment of the invention comprises an interactive storybook 100 that provides an interactive medium through which both children and adults can enjoy a story. In one embodiment of the invention, the storybook 100 comprises an outer housing 105 that defines one or more recesses 170 for receiving one or more, preferably 3-dimensional, story modules 200 (See FIG. 2). As shown in FIG. 4, a story module exterior indicia 240 is preferably included on an exterior surface of one or more of the story modules 200. This exterior indicia 240 preferably indicates the portion of the story (e.g., chapter number or title) to which the particular story module 200 corresponds. For example, a story module 200 corresponding to the sixth part (e.g., chapter or paragraph) of a story might include the symbol “6” or “VI” as its story module exterior indicia 240.

In one embodiment of the invention, one or more of the story modules 200 is configured to be moved into a closed position in which one or more interior surfaces (and preferably a plurality of, or all, of the story module's interior surfaces) are at least partially (and preferably entirely) obstructed from view. Thus, in one embodiment of the invention, a user viewing a story module 200 in the closed position would not be able to see what was within the interior of the story module (e.g., any objects inside the story 200 module or anything painted or printed on the interior walls of the story module 200). However, the story modules 200 are preferably configured so that a user can view the story module's exterior indicia 240 when the story module 200 is in a closed position. In one embodiment of the invention, this allows users to store the story modules 200 in a closed position (for example, within an outer housing 105) and easily determine which particular story module 200 corresponds to a particular portion of a story.

FIG. 2, for example, shows nine different story modules 200 that are stored in a closed position within an outer housing 105. Similarly, FIG. 4 shows a story module 200 (with an exterior indicia of “VI”) in a closed position.

The story module exterior indicia 240 also allow users to easily place the story modules 200 in an appropriate order that corresponds, for example, to a chronological order of individual story portions to which the various story modules 200 correspond. For example, a particular storybook 100 may include nine story modules 200, each of which corresponds to a chapter in a particular story conveyed by the storybook 100. In one embodiment of the invention, the exterior indicia 240 of each particular story module 200 visually represents the chapter to which that particular story module 200 corresponds. A user may thus place the story modules 200 in the correct chronological order by placing the story modules 200 in a correct alphanumeric sequence (e.g., by placing them in increasing sequential numerical order from 1 through 9).

In one embodiment of the invention, however, the story modules 200 are configured so that they may be ordered in many different sequences to create unique stories that change based upon the order in which the story modules 200 are read. This allows users to obtain a sense of how a story may change simply by changing the relative chronology of events within a particular story.

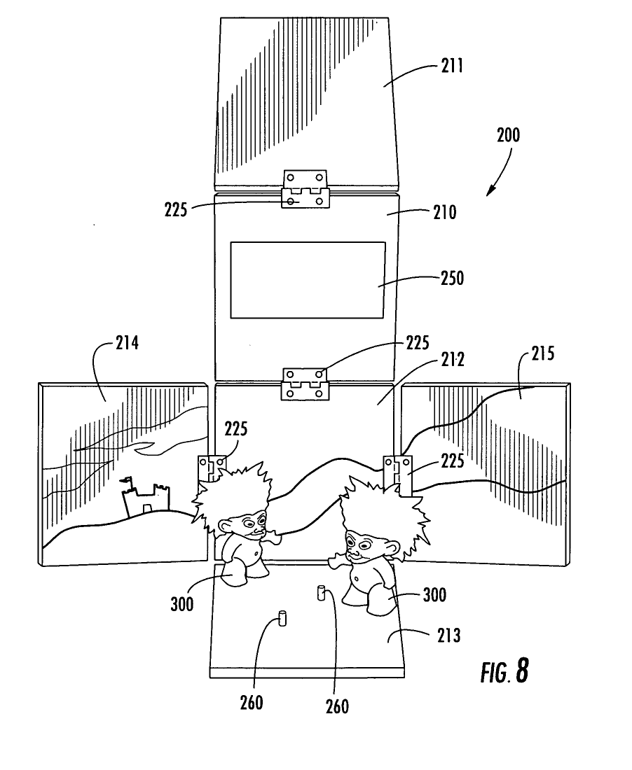

One or more of the story modules 200 is also preferably configured to be moved into on open position in which one or more of the interior surfaces of the story module 200 are exposed for viewing. FIG. 8 shows an example of a story module 200 in an open position. As may be understood from this figure, in one embodiment of the invention, when the story module 200 is in an open position, an interior indicia 250 corresponding to a portion of a story is available to a user. In one embodiment of the invention, this interior indicia 250 includes a printed card that includes the text that corresponds to a particular portion of a story.

In one embodiment of the invention, the storybook 100 comprises a plurality of story modules 200, each of which includes an interior indicia 250 that conveys a portion of a story. Preferably, the various story modules within a particular storybook 100 together comprise all of the parts of a particular story (e.g., in text, video, audio, or any other format). This allows a user to experience the story by opening and appropriately interacting with (e.g., reading, listening to, or viewing) the interior indicia within each story module 200.

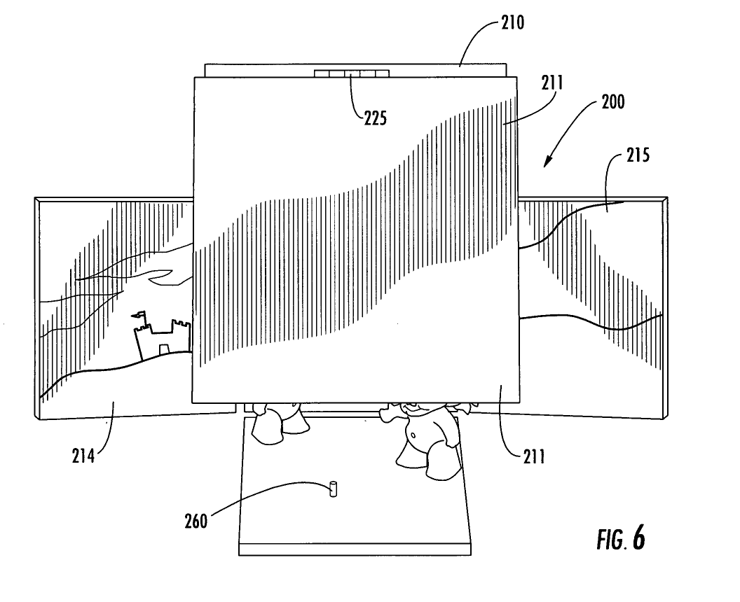

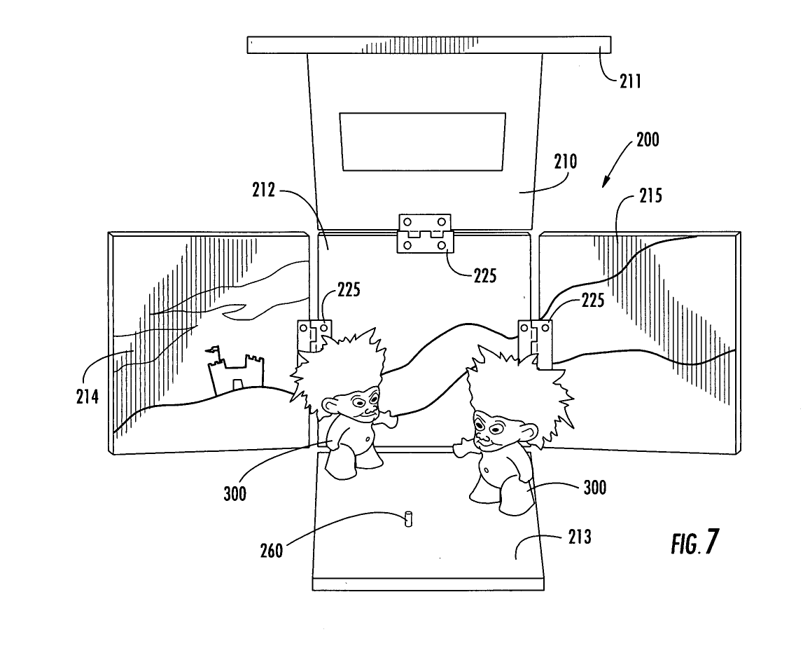

As may be understood from FIGS. 6-8, in one embodiment of the invention, one or more of the story modules 200 includes a plurality of panels 210-215. In this embodiment, at least one of the panels (such as stage panel 213) preferably defines a stage surface (e.g., a surface that is preferably configured for supporting story props, such as dolls). Additionally, at least one of the other panels serves as a background portion for displaying a background scene (much like the background displays used in a play). In one embodiment of the invention, two, three or more panels serve as background panels. For example, in FIG. 8, panels 212, 214 and 215 serve as background panels. In a preferred embodiment of the invention, the panels 210-215 are configured so that at least one of the background panels is positioned so that at least a portion of that background panel forms an angle of about 90 degrees with at least a portion of the stage panel 213. Similarly, in one embodiment of the invention, at least one of the background panels 212, 214, 215 is positioned adjacent one edge (preferably a rear edge) of the stage panel 213.

An example of a particular configuration of the various story module panels 210-215 is shown in FIG. 8. In this figure, panel 213 is a stage panel, and panels 212, 214 and 215 serve as background panels. As may be understood from these figures, the stage and background panels 212-215 preferably cooperate to form a background and stage setting that is adapted for allowing users to act out a scene with props 300 (e.g., dolls and other figures such as trees) in a theater-like manner (e.g., with a substantially fixed background display and props).

In a particular embodiment of the invention, one of the story module panels 210-215 includes an interior indicia 250 that serves to convey at least a portion of a story. For example, in FIG. 8, the interior indicia 250 includes the text of a portion of a story titled “The Empty Sorcerer”. Thus, as may be generally understood from FIG. 8, each story module 200 is configured to allow users to open the story module 200, take in (e.g., read, view, or listen to) part of a story via the interior indicia 250, and then act out that part of the story in a theater-like manner by moving and positioning props 300 adjacent the stage and background panels 212-215.

In one embodiment of the invention, a prop holder (such as an elongate stake member) 260 is provided adjacent at least one of the story module panels 210-215 for holding props in a particular position relative to the panels. For example, FIG. 8 depicts a stage panel 213 that includes two male prop holders 260. In one embodiment of the invention, one or more of the props 300 is configured to be positioned so that the prop holder 260 extends into the interior of a recess in the prop 300 and, through frictional contact between the prop holder 260 and the interior of the prop's recess, hold the prop 300 in a particular position relative to the story module panels 210-215. For example, in one embodiment, a wizard prop 300 is positioned so that a prop holder 260 extends into a recess in the front portion of a wizard prop 300 (e.g., adjacent the wizard prop's “navel”). This gives the wizard prop 300 the appearance of flying.

Other known devices may also be used as prop holders. For example, one or more of the panels 210-215 and one or more of the props may include Velcro strips that allow users to temporarily adjoin various props 300 with various panels 210-215 in a manner known in the art. Straps, snaps, magnets, or any of a variety of other fasteners may also be used for this purpose.

Returning briefly to the interior indicia 250 (an example of which is shown in FIG. 8), in one embodiment of the invention, the interior indicia 250 comprises a surface that is configured to allow users to change the text on the interior indicia 250. For example, the interior indicia may comprise a portion of dry-erase board that allows users to easily write text onto the board and erase the text as needed. This allows users to make up their own story segments, and then act out these segments using props provided within the interior of the story modules 200. In one embodiment of the invention, the interior indicia comprises a digital display screen that allows users to input and modify digital text (e.g., via a connection to a computer, keyboard, or wireless network). In another embodiment of the invention, a reusable writing surface (such as a dry erase board) is disposed adjacent the interior surface of one or a plurality of the story module panels. In various embodiments of the invention, providing a plurality of panels with such a reusable writing surface allows users to both customize the text of their stories and create custom background art, as desired.

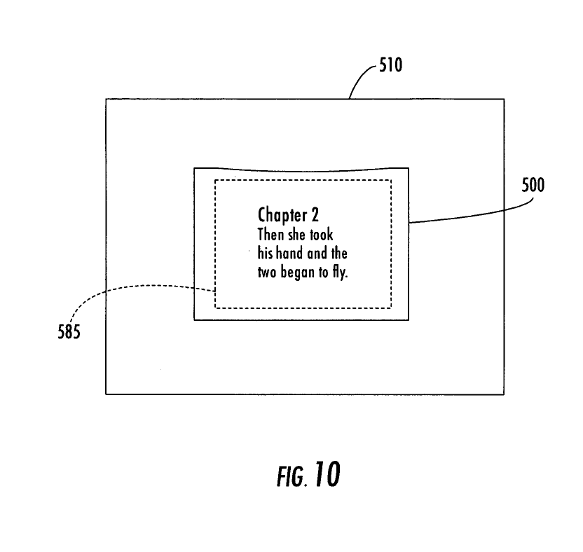

In yet another embodiment of the invention, one or more of the story modules comprises an interior indicia receiving portion 500 for removeably receiving one or more interior indicia cards 510. For example, in an embodiment of the invention shown in FIG. 10, the interior indicia receiving portion 500 is a transparent pouch that is affixed to an interior surface of one of the story module panels 510. This transparent pouch is configured for receiving at least one indicia card 585 into the interior of the transparent pouch 500 so that text on the indicia card (preferably corresponding to a portion of a story) may be viewed through the pouch's transparent material.

In another embodiment of the invention, the interior indicia receiving portion comprises a portion of Velcro material, and the story module 200 comprises one or more interior indicia cards that include a Velcro portion on one side of the card and the text of a story portion on the opposite side of the card. This allows users to easily modify the text displayed within the story modules by simply replacing a current interior indicia card with a new interior indicia card. In one embodiment of the invention, the interior indicia cards may be sold in sets of story cards (each set of story cards corresponding to a particular story) to allow users to modify a single storybook to tell many different stories (e.g., by replacing a current set of story cards within the storybook with a different set of story cards).

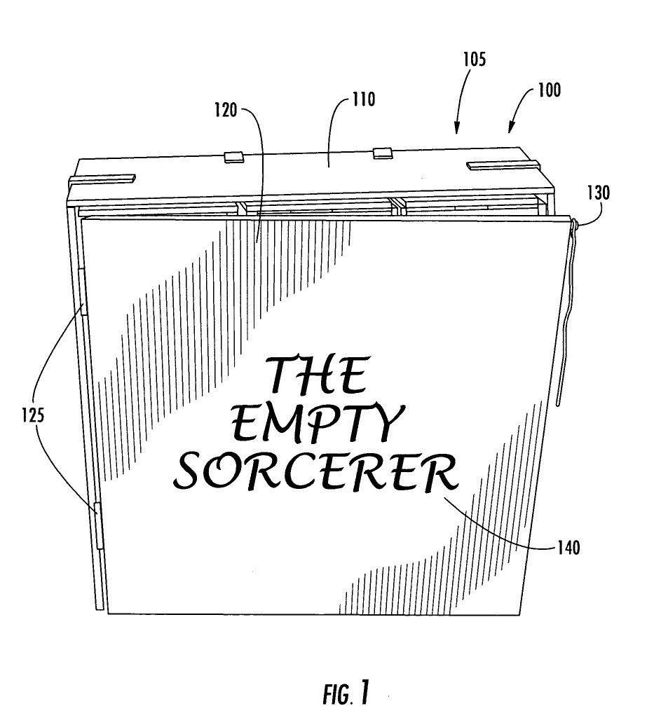

Also, in one embodiment of the invention, a storybook exterior indicia 140 (See FIG. 1) on the exterior of the storybook 100 is also configured to be easily changed by the user (e.g., by temporarily affixing an exterior indicia card to the exterior surface of the door 130) to correspond to the title of the story told by the various story modules. (This storybook exterior indicia 140 may alternatively be permanently affixed to the storybook.)

As will be understood by one skilled in the art, the exterior and interior indicia cards discussed above may be removably attached to the appropriate portions of the storybook 100 using any appropriate fastener or other mechanism. Examples of such fasters and mechanisms include: Velcro, magnets, and transparent pouches that are affixed to the appropriate surface of the storybook and that are configured for receiving an appropriately sized exterior or interior indicia card. Such transparent pouches are advantageous because they allow the various indicia cards to be easily replaced, and also protect the indicia cards from stains or improper handling.

FIG. 1 shows a storybook 100 according to a particular embodiment of the invention in which the storybook 100 is in a substantially closed configuration. As may be understood from this figure, in this embodiment of the invention, the storybook 100 comprises an outer housing 105 that comprises a storybook module retaining portion 110 (which may be, for example, substantially in the form of a hollow cabinet with shelves) and a door 120.

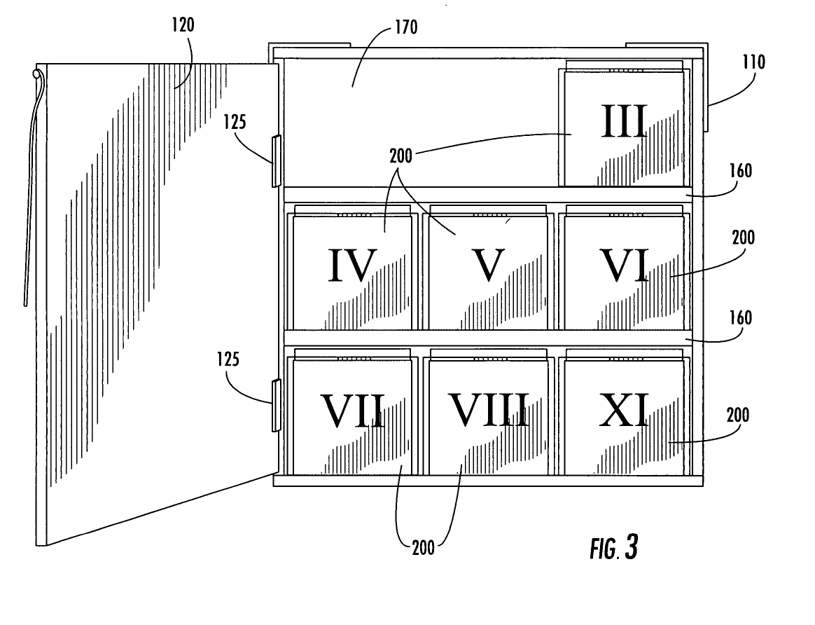

FIGS. 2 and 3 show the storybook 100 with the storybook's door 120 is in an open position. As may be understood from these figures, the door 120 is configured for selectively restricting access to an interior portion defined by the storybook module retaining portion 110. As may be understood from FIGS. 2 and 3, the storybook module retaining portion 110 is preferably configured to receive one or more story modules 200, which are discussed above. The storybook module retaining portion 110 also preferably comprises one or more horizontal shelves 160 for providing support for one or more of the story modules 200.

In another embodiment of the invention (not shown), the storybook module retaining portion 110 may also include one or more vertical dividers for providing a vertical barrier between two or more of the story modules 200. In a preferred embodiment of the invention, the storybook module retaining portion 110 defines at least one individual compartment that is dimensioned to receive only one individual story module 200. In one embodiment of the invention, this compartment is dimensioned to substantially conform to an outer surface of a particular individual story module 200.

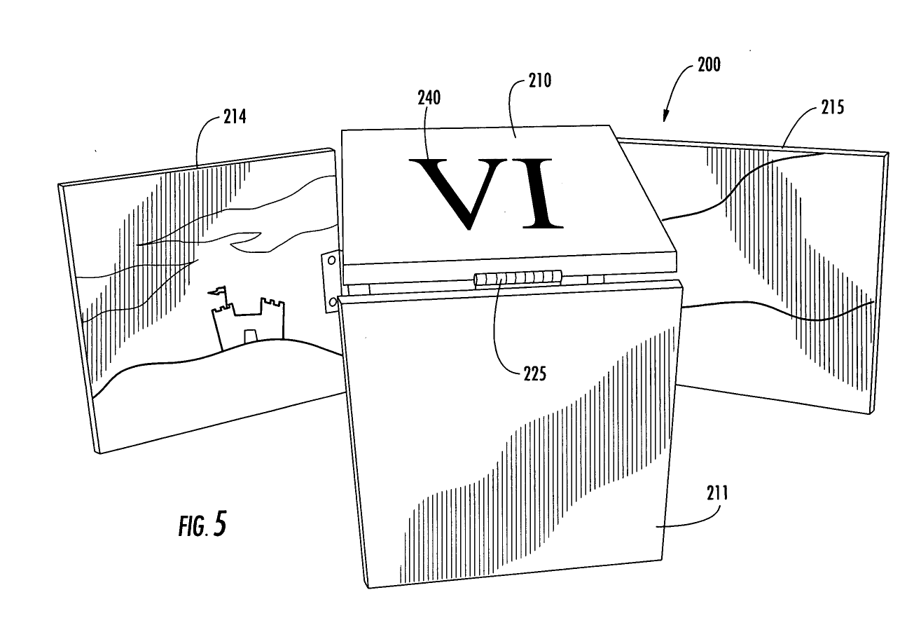

FIGS. 5-8 depict a story module 200 according to a particular embodiment of the invention in various configurations. As may be understood from these figures, this story module 200 is configured to be moved from a closed position in which the story module is substantially in the form of a cube, and into an open position in which one or more interior portions of the story module 200 are exposed to a user. As shown in FIGS. 5 through 8, in one embodiment of the invention, one or more of the story module panels 210-215 (specifically, in this embodiment, story module panels 210 and 211) interact to provide the effect of a curtain being raised (as in a play) when the panels are moved from a closed to an open position. This provides an enhanced dramatic effect when the story modules are opened.

As may be understood from FIG. 8, in one embodiment of the invention, a central background panel 212 is attached (e.g., substantially rigidly attached) adjacent a stage panel 213 (e.g., with L-brackets) so that these two panels 212, 213 form a generally L-shaped formation. In one embodiment of the invention, this L-shaped formation is substantially rigid. Also, in a particular embodiment, a first side background panel 214 is attached (preferably via a hinge 225) to the central background panel 212 adjacent a first side edge of the central background panel 212 as shown in FIG. 8. Similarly, a second side background panel 215 is attached (preferably via a hinge 225) to the central background panel 212 adjacent a second side edge (e.g., an edge that is parallel to and offset from the first side edge) of the central background panel 212 as shown in the various figures. In addition, a first upper panel 210 (preferably including an interior indicia 250) is attached (preferably via a hinge 225) adjacent a top edge of the central background panel 212. As shown in FIG. 8, a second upper panel 211 is attached (preferably via a hinge) to the outer edge 227 of the first upper panel 210 (e.g., so that the first upper panel 210 is disposed substantially between the second upper panel 211 and the central background panel).

As may be understood from FIGS. 4 through 8, the various panels 210-215 are preferably configured so that that they may be moved from a closed position, in which the panels form a substantially cube shape, to an open position, in which the various background and upper panels 210-212 and 214-215 form a substantially planer T-shape, and the stage panel 213 extends outwardly from the top center portion of the T-shaped array of panels 210-212; 214-215. In a preferred embodiment of the invention, when the story module 200 is in a particular open position, the angle formed by: (1) the background and upper panels 210-212 and 214-215; and (2) the plane formed by the stage panel 213, is approximately 90 degrees.

Other Embodiments of the Invention

Although the story modules 200 described in regard to the embodiment above are generally in the shape of a cube when closed, as will be understood by one skilled in the art in light of this disclosure, one or more of the story modules 200 may be made in any convenient three dimensional or two dimensional shape or form. Thus, one or more of the various story modules 200 may be, for example, in the form of a three-dimensional rectangular shape, a pyramid, a cone, or a cylinder.

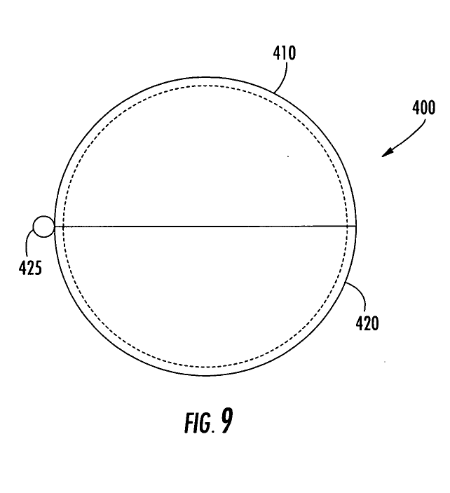

For example, as shown in FIG. 9, in one embodiment of the invention, one or more of the individual story modules 400 may be generally in the form of a hollow sphere. As may be understood from this figure, in one embodiment of the invention, at least one story module 400 comprises a hollow sphere that comprises two hollow substantially hemispherical story module portions 410, 420 that are attached, preferably via a hinge 425, so that they can be moved between: (1) a closed position, in which the two story module portions 410, 420 cooperate to form a hollow sphere 400 (see FIG. 9), and (2) an open position, in which interior portions of the two story module portions 410, 420 are exposed. This allows users, for example, to access an interior indicia (such as the interior indicia 250 discussed above) disposed, for example, on an interior surface of one of the story module portions 410, 420. This allows the user to acquire the information conveyed by the interior indicia by, for example, reading a portion of a story written on the interior indicia.

In another embodiment of the invention, the story modules are actually individual “sub-books” within a larger book. Thus, each story module is in the form of a small book that only tells one portion of a larger story and that may be individually manipulated and read separately from the larger book. In a preferred embodiment of the invention, one or more of the sub-books includes a surface, such as a dry-erase surface, that allows users to easily write or draw on the surface and then later erase the surface so that they can write a new story portion or draw a new drawing on the surface.

In a particular embodiment of the invention, the storybook module comprises electronic components (such as those known in art in various Halloween-themed toys) to create an audio or visual effect in response to: (1) one or more of the storybook modules being moved from a closed to an open position; and/or (2) one or more of the storybook modules being removed from the module retaining portion. Such audio effects may include for example, playing an electronic noise or song. Such visual effect may include, for example, executing a lighting effect (such as strobe lights) within the interior of the storybook module or generating simulated smoke within the interior of the storybook module.

Exemplary Inventive Methods

A method according to one embodiment of the invention comprises the steps of: (1) providing an outer housing defining a recess; and (2) providing one or more story modules within said recess, each of said story modules corresponding to a portion of a story. In one embodiment of the invention, one or more of the story modules comprises a stage surface, and a background surface. The stage surface is configured for supporting one or more props for use in acting out a portion of a story. The background surfaces are configured for providing a background display that is conducive to conveying the portion of the story being acted out using the props. One or more of the story modules preferably includes one or more props that are stored within an interior portion defined by the story module when the story module is in a closed position. In one embodiment of the invention, the storybook does not include an outer housing, but is simply comprised of a plurality of story modules.

Assembly and Materials

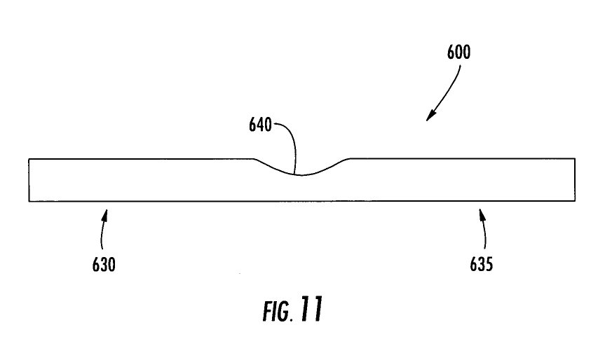

As will be understood by one skilled in the art, various embodiments of the invention may be made of any suitable material such as wood, metal, plastic, or paper-based materials. Also, as will be understood by one skilled in the art, two or more of the various panels may be permanently attached, or made from a single piece of material. In such an embodiment of the invention, the hinged relationship between the panels may be provided by an indentation between the two panels. An example of this embodiment, in which the panels are preferably made of a flexible material such as plastic, is shown in FIG. 11.

Conclusion

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What I claim is:

1. A method of executing a fake smoke effect comprising:
allowing a user to open a book; and
in response to said user opening said book, executing said fake smoke effect.
